(19) United States
(12) Patent Application Publication
(10) Pub. No.: US 2011/0043693 A1
(43) Pub. Date: Feb. 24, 2011

(54) SYNCHRONOUS CONTROL CIRCUIT AND VIDEO DISPLAY DEVICE

(76) Inventors: Hiroyuki Nakahira, Osaka (JP); Takashi Yamamoto, Fukuoka (JP); Kouji Okamoto, Osaka (JP); Akira Yamamoto, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/885,838

(22) Filed: Sep. 20, 2010

Related U.S. Application Data
(63) Continuation of application No. PCT/JP2009/001237, filed on Mar. 19, 2009.

(30) Foreign Application Priority Data
Mar. 21, 2008 (JP) 2008-072922

(51) Int. Cl. H04L 7/00; H04N 9/475

(52) U.S. Cl. 348/512; 375/371; 348/E09.034

(57) ABSTRACT

A synchronization control circuit is provided with a first sampling means for sampling the envelope signal of the modulation signal at a first sampling timing, a second sampling means for sampling the envelope signal at a second sampling timing, a third sampling means for sampling the envelope signal at a third sampling timing, a phase error calculation means for calculating a phase error value indicating the amount of synchronization deviation between the modulation signal and the reference clock signal using the outputs of the first, second, and third sampling means, a delay control means for generating a delay control signal on the basis of the phase error value, and a delay generation means for generating the first, second, and third sampling timing by delaying the reference clock signal based on the delay control signal. Thereby, a synchronization control circuit that can reduce the circuit size required for obtaining the synchronization with relative to the Early/Late system can be provided.

### TECHNICAL FIELD

The present invention particularly relates to a synchronous control circuit for establishing the synchronization between the modulation signal which was received by wireless communication and the reference clock and a video display device which includes such a synchronization circuit.

### BACKGROUND ART

As a subject for a wireless communication, there is raised that the establishment of temporal synchronization is difficult. In a wireless communication system, while the receiver's side extracts data from the signal transmitted from the transmitter side, in order to exactly extract data from the received signal, it is required that the clocks at the transmitter side and the clocks at the receiver side are synchronized with each other

However, the receiver side does not include information of the clocks at the transmitter side. Even if such information are included at the receiver side, since the signals which are subjected to the affections by the transmission paths are inputted, it was very difficult to accomplish synchronization for both of frequency and phase.

As an example of a prior art synchronization method, there was an Early/Late DLL (Delay Locked Loop) system (for example, refer to patent reference 1). FIG. 10 shows a diagram illustrating a construction of a receiving device as disclosed in patent reference 1. FIG. 11 shows a relation between the received signal and the sample data for establishing the synchronization in the patent reference 1.

In the above-described prior art receiving device, first of all, the received signal is sampled successively at three points. Next, the difference between the first sample value and the third sample value is taken, and the correlation value there between is obtained. The sample timings are adjusted so that the correlation value therebetween becomes zero, and the synchronization is established when the correlation value therebetween has become zero. Then, since the second sample value is located at the peak point of the received signal, the data can be demodulated by using that correlated value therebetween.
Patent reference 1: Japanese Patent Publication No. 2005-518111

### DISCLOSURE OF THE INVENTION

### Object to be Solved by the Invention

However, in the prior art Early/Late DLL system, the correlation circuit for taking the correlation between the differences between the two samples for taking synchronization, the correlation circuit for demodulation, and two A/D converters for each of the respective circuits are required, and therefore, the circuit size would have increased, and further the power dissipation would have also increased.

The present invention is directed to solving the above-described problems and has for its object to provide a synchronization control circuit which can reduce the circuit size for synchronizing the clocks at the transmitter side and the clocks at the receiver side and further can reduce the power dissipation with relative to the prior art Early/Late system.

In addition, the present invention has for its object to provide a video display device which can reduce the sizes of the circuits required for synchronizing the clocks at the transmitter side and the clocks at the receiver side as well as can reduce the power dissipation.

### Measures to Solve the Problems

In order to solve the above-described problems, there is provided a synchronization control circuit of claim 1 for receiving an envelope signal of a modulation signal and a reference clock signal, and establishing timing synchronization between the modulation signal and the reference clock signal, which comprises: a first sampling means for sampling said envelope signal at a first sampling timing to produce a first sample value; a second sampling means for sampling said envelope signal at a second sampling timing to produce a second sample value; a third sampling means for sampling said envelope signal at a third sampling timing to produce a third sample value; a phase error calculation means for calculating a phase error value indicating the amount of synchronization deviation between said modulation signal and said reference clock signal using said first, second, and third sample values; a delay control means for generating a delay control signal indicating a required delay amount on the basis of the phase error value which is outputted from the phase error calculation means; and a delay generation means for generating said first, second, and third sampling timing by delaying said reference clock signal based on said delay control signal.

According to claim 2 of the present invention, there is provided a synchronous control circuit as defined in claim 1, wherein said phase error calculation means detects the rising up or falling down of said envelope signal using said first and third sample values among said successive first, second, and third sample values, and calculates the phase error value using said second sample value when said rising up or falling down of said envelope signal is detected, and said delay control means generates said delay control signal so that said phase error value becomes zero.

According to claim 3 of the resent invention, there is provided a synchronous control circuit as defined in claim 1 or 2, wherein said delay generation means comprises: a first delay means for generating said first sample timing by delaying said externally inputted reference clock signal according to said delay control signal; a second delay means for generating said second sample timing by delaying the output of said first delay means by a predetermined amount; and a third delay means for generating said third sample timing by delaying the output of said second delay means by a predetermined amount.

According to claim 4 of the present invention, there is provided a synchronous control circuit as defined in any of claims 6 to 3, wherein said first and third sampling means comprise a two-value or three-value comparator, respectively, and said second sampling means is an A/D converter of two or more bits.

According to claim 5 of the present invention, there is provided a synchronous circuit as defined in any of claims 1 to 4, wherein either of said first sample value or said third sample value is employed, as demodulated data.

According to claim 6 of the present invention, there is provided a synchronous control circuit for receiving an envelope signal of a modulation signal and a reference clock signal, and establishing timing synchronization between the modulation signal and the reference clock signal, which comprises: a T/D conversion means for subjecting time-digital conversion to said envelope signal employing sampling clocks; a phase error calculation means for calculating a phase error value indicating the amount of synchronization deviation between said modulation signal and said reference clock signal using the output of said T/D conversion means; a delay control means for generating a delay control signal indicating a required delay amount on the basis of the phase error value which is outputted from the phase error calculation means; and a delay generation means for generating said sampling clocks by delaying said reference clock signal according to said delay control signal.

According to claim 7 of the present invention, there is provided a synchronous control circuit as defined in claim 1, wherein said T/D conversion means includes a plurality of stages of delay means which receive an envelope signal of said modulation signal and a plurality of sampling means for sampling the respective output values of said plurality of stages of delay means.

According to claim 8 of the present invention, there is provided a synchronous control circuit as defined in claim 7, wherein said plurality of sampling means are ones which sample the respective output values of the plurality of stages of delay means by two values, and said delay control means generates said delay control signal so that the difference in the respective numbers of the two values which are respectively sampled by the plurality of sampling means is lower than a constant value.

According to claim 9 of the present invention, there is provided a video display device comprising: a wireless receiver apparatus including a detection means for detecting an envelope signal of a modulation signal, a clock generation means for generating a reference clock signal, a synchronous control circuit for synchronizing the timings of the modulation signal and the reference clock signal; an LSI having a signal processor for demodulating said modulation signal. including audio data and video data on the basis of the demodulated data which is obtained by said wireless receiver apparatus; and a display terminal for receiving the demodulated signal from said LSI and emitting sound of said demodulated audio data as well as displaying said demodulated video data; wherein said synchronous control circuit comprises: a first sampling means for sampling said envelope signal at a first sampling timing to produce a first sample value; a second sampling means for sampling said envelope signal at a second sampling timing to produce a second sample value; a third sampling means for sampling said envelope signal at a third sampling timing to produce a third sample value; a phase error calculation means for calculating a phase error value indicating the amount of synchronization deviation between said modulation signal and said reference clock signal using said first, second, and third sample values; a delay control means for generating a delay control signal indicating a required delay amount on the basis of the phase error value which is outputted from the phase error calculation means; and a delay generation means for generating said first, second, and third sampling timing by delaying said reference clock signal based on said delay control signal.

According to claim 10 of the present invention, there is provided a video display apparatus comprising: a wireless receiver apparatus including a detection means for detecting an envelope signal of a modulation signal, a clock generation means for generating a reference clock signal, a synchronous control circuit for synchronizing the timings of the modulation signal and the reference clock signal; an LSI haying a signal processor for demodulating said modulation signal including audio data and video data on the basis of the demodulated data which is obtained by said wireless receiver apparatus; and a display terminal for receiving the demodulated signal from said LSI and emitting sound of said demodulated audio data as well as displaying said demodulated video data; wherein said synchronous control circuit comprises: a T/D conversion means for subjecting said envelope signal to time-digital conversion by sampling clocks; a phase error calculation means for calculating a phase error value indicating the amount of synchronization deviation between said modulation signal and said reference clock signal using the output of said T/D conversion means; a delay control means for generating a delay control signal indicating a required delay amount on the basis of the phase error value which is outputted from the phase error calculation means; and a delay generation means for generating said sampling clocks by delaying said reference clock signal according to said delay control signal.

### EFFECTS OF THE INVENTION

According to a synchronous control circuit of the present invention, since it is configured such that the rising up and the falling down of the envelope signal are detected from the outputs of the two comparators which have predetermined thresholds and an A/D converter which calculates a phase error difference, and the phases of the sample clocks for sampling the outputs of the comparators and the A/D converter are adaptively controlled based on the synchronization deviation amount at the detection, the timing synchronization between the received signal and the reference clock can be accomplished without employing a plurality of A/D converters, thereby the circuit size that is required for realizing synchronization of timings can be reduced, as well as the power dissipation required can be suppressed.

In addition, according to a synchronous control circuit of the present invention, since it is configured such that the rising up and falling down of the envelope signal are detected employing a T/D converter and the phases of the sample clocks are adaptively controlled so that the rising up and falling down of the envelope signal come to the vicinity of the center of the sample clocks, the circuit size that is required for realizing synchronization of timings between the received signal and the reference clock can be reduced, as well as the power dissipation required can be reduced. Since the timing synchronization between the received signal and the reference clock can be taken without employing an A/D converter, the circuit size that is required for taking the timing synchronization as well as the power dissipation can be further reduced.

In addition, by employing a synchronous control circuit according to the present invention for a video display apparatus which performs wirelessly a data transmission with an external apparatus, the circuit size and the power dissipation of a video display apparatus can be suppressed.

### BRIEF DESCRIPTION OF THE DRAWINGS

FIG. 1 is a diagram illustrating a construction of a phase control circuit in a first embodiment of the present invention.

FIG. 2 is a diagram illustrating sample timings in the first embodiment of the present invention.

FIG. 3 is a diagram illustrating phase error values in the first embodiment of the present invention.

FIG. 4 is a diagram illustrating constructions of the phase error calculation circuit and the delay control circuit in the first embodiment of the present invention.

FIG. 5 is a diagram illustrating a construction of the delay generation circuit in the first embodiment of the present invention.

FIG. 6 is a diagram illustrating a construction of the phase control circuit in a second embodiment of the present invention.

FIG. 7 is a diagram illustrating sample timings in the second embodiment of the present invention.

FIG. 8 is a diagram illustrating constructions of the phase error calculation circuit and the delay control circuit in the second embodiment of the present invention.

FIG. 9 is a diagram illustrating an entire schematic construction of a video display apparatus provided with a wireless receiver apparatus which has installed the phase control circuit of the present invention.

FIG. 10 is a diagram illustrating a construction of a prior art receiver apparatus.

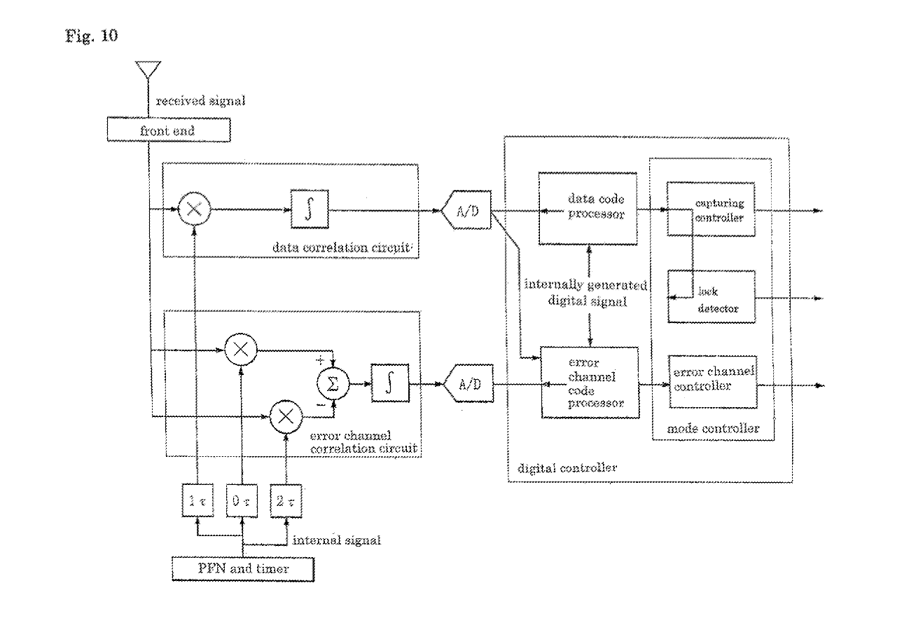

FIG. 11 is a diagram illustrating sample timings in the prior art receiver apparatus.

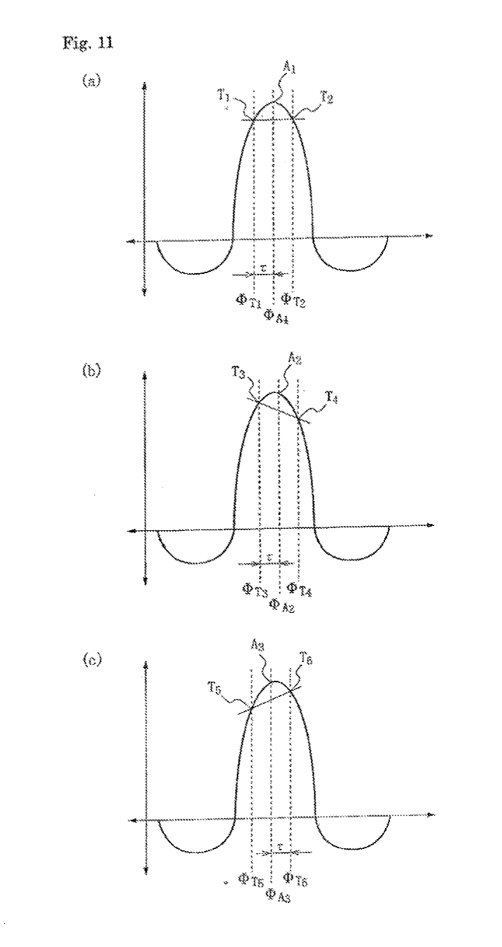

### DESCRIPTION OF REFERENCE NUMERALS

100, 200 wireless receiver apparatus
101 input signal
102 envelope signal
103 first sample value
104 second sample value
105 third sample value
106, 109 comparators
107, 110, 126, 204, 212-1 to 212-m D-flip flop
111 detector circuit
112, 202 phase error calculation circuit
113, 203 delay control. circuit.
114 reference clock circuit
115, 116, 117, 211-1 to 211-m delay generation circuit
121, 122 multiplier
123, 132 multiplexer
124 gain amplifier
125 adder
131 decoder circuit
133-1 to 133-n delay circuit
201 T/D converter
221, 222 counter
223 subtraction circuit
300 video display apparatus
301 digital camera
302 LSI
303 display terminal
304, 305 antenna
310, 311 DSP
312 CPU
313 memory
CLK reference clock
CKA, CKB, CKC sample clock

### BEST EMBODIMENTS CARRYING OUT THE INVENTION

### First Embodiment

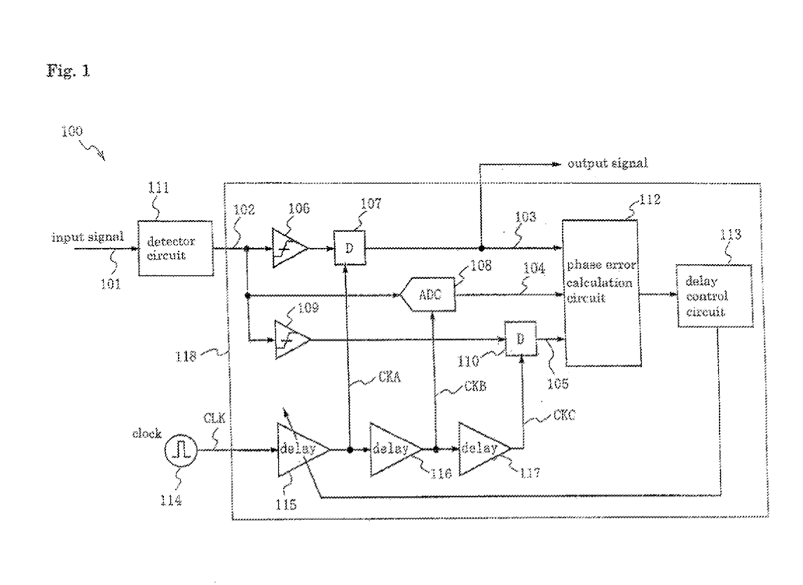

FIG. 1 is a diagram illustrating a construction of a wireless receiver apparatus installing a synchronous control circuit 118 according to a first embodiment of the present invention.

The wireless receiver apparatus 100 is provided with a detector circuit 111, a synchronous control circuit 118, and clocks 114.

The detection circuit 111 is one which detects the envelope signal 102 from the modulation signal which comprises data superposed on the carrier wave, and generally it is constituted by a low noise amplifier or a mixer, or a filter for removing interference waves and image signals. The characteristics and arrangements of the amplifier, mixer, or filter circuits as their constitutional elements are different dependent on the information handled. The detail of these are not particularly illustrated here.

The synchronous control circuit 118 includes comparators 106, 109, D-flip flops 107, 110, A/D converter 108, phase error calculation circuit 112, the delay control circuit 113, and delay generation circuits 115, 116, and 117. The clock 114 comprises reference clock CLK.

The comparators 106 and 109 are those which compare the envelope signal 102 which is detected by the detector circuit 111 and the predetermined thresholds thereby to output the result as a binary or a ternary value. The value is, for example, 0 and 1 or −1 and +1 when it is binary, and −1, 0, and +1 when it is ternary. In this first embodiment, in order to simplify the description, a binary value comprising −1 and +1 will be taken. The method of setting a predetermined threshold is not illustrated here, but it can be set variably by an external or internal microcomputer or a sequencer.

The D-flip flops 107 and 110 are those which hold the outputs of the comparators 106 and 109, respectively, and the output thereof comprises one bit when the outputs of the comparators 106 and 109 are binary, while it comprises 2 bits when they are ternary.

The output signal of the synchronous control circuit 118 is made comprising the output of the D-flip flop 107 as shown in FIG. 1 when the output of the comparator 106 is binary. When the output of the comparator 106 is ternary, though it is not shown here, if the output of the comparator 106 is +1 or −1, it is outputted as it is, and when it is 0, +1, or −1 is outputted dependent on the value of the uppermost bit of the output of the A/D converter which constitutes said comparator.

For the output signal of the synchronous control circuit 118, the output of the D-flip flop 110 may be employed, and even in such case, the operations of the comparator 109 and the D-flip flop 110 are the same as the above-described operations of the comparator 106 and the D-flip flop 107.

The A/D converter 108 is one which converts the envelope signal 102 as an analogue signal to a digital signal by a sample clock CKB, and the output bit width thereof is 2 bits or more.

The phase error calculating circuit 112 is one which receives the sample values 103, 105 as the outputs of the D-flip flop 107, 110 and the sample value 104 as the output of the A/D converter 108 as its inputs and calculates the phase error value for controlling the delay control circuit 113.

The delay control circuit 113 is one which generates a delay control signal for controlling the delay amount in the delay generation circuit 115 based on the output of the delay error calculation circuit 112.

The delay generation circuit 115 receives the clock CLK which is outputted from the clock 114 as its input, and outputs a sample clock CKA which is obtained by delaying the clock CLK by a predetermined amount according to the delay control signal from the delay control circuit 113. The delay generation circuit 116 receives the sample clock CKA as its input and delays the sample clock CKA by a predetermined amount to output the sample clock CKB. The delay generating circuit 117 receives the sample clock CKB as its input and delays the sample clock CKB by a predetermined amount to output the sample clock CKC. Here, the signal delay amounts of the delay generation circuit 116 and 117 are fixed values.

Next, the delay control method for establishing synchronization in the synchronous control circuit 118 according to the first embodiment of the present invention will be described.

The judgment of the synchronous state is performed only at the rising up and falling down of the envelop signal 102.

First of all, the judgments of the rising up and falling down of the envelope signal 102 are performed using the sample values 103, 105 due to the sample clocks CKA, CKC in the phase error calculating circuit 112. The threshold values of the comparators 106 and 109 are made the center levels, and if the sample value is larger than the threshold value, respectively, the output is made +1, if the sample value is less than the threshold value, the output is made −1.

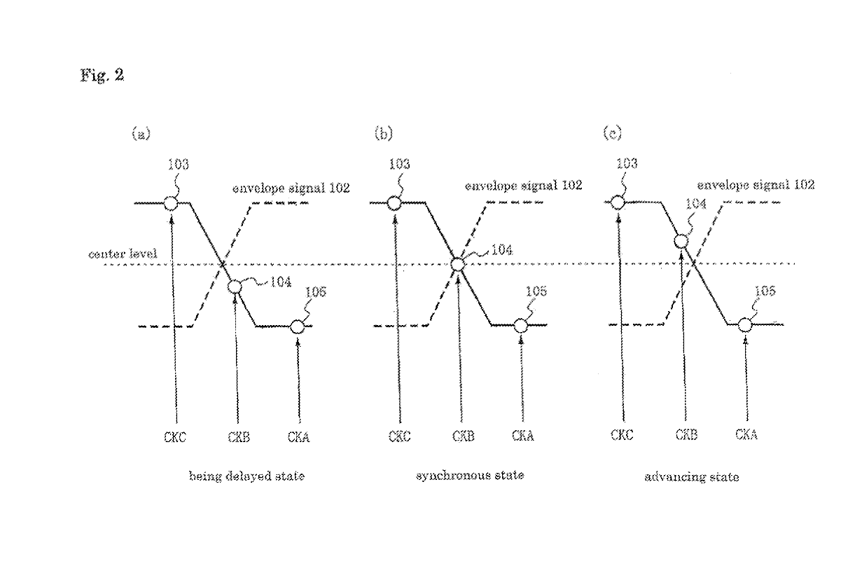

Then, as can been seen from FIG. 2a to FIG. 2c, when the sample value 103 is different from the sample value 105, i.e., when one is +1 while the other is −1, it is found that there is a rising up or falling down of the envelope signal 102. Then, if the sample value. 104 is less than the center level, the sample timing is delayed than a desired synchronous timing (FIG. 2a). If the sample value 104 is at the center level, the sample timing is in timing, i.e., the synchronization is taken (FIG. 2b), and if the sample value 104 is larger than the center level, the sample timing is in advance than a desired synchronous timing (FIG. 2c).

Next, a procedure for taking synchronization when it is deviated from a desired synchronization timing will be described.

First of all, it is noted on the sample values 104 at timings when the rising up or the falling down of the envelope signal 102 is detected. The difference between the sample value 104 and the center level is made the phase error value.

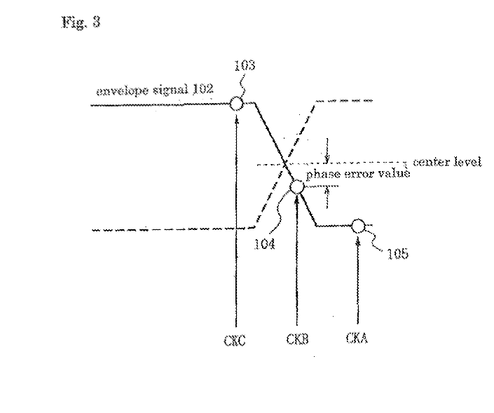

In FIG. 3, if the center level is made 0 and the sample value 104 is made −4, the difference there between, i.e., −4 is the phase difference value. Since the sign of the phase difference value is minus and the deviation in the synchronous timing then is the delayed state as described above, the larger the absolute value of the phase error value is, the larger the deviation in the synchronous timing is. By feeding back this phase difference value, it is possible to modify the deviation in the synchronization timing.

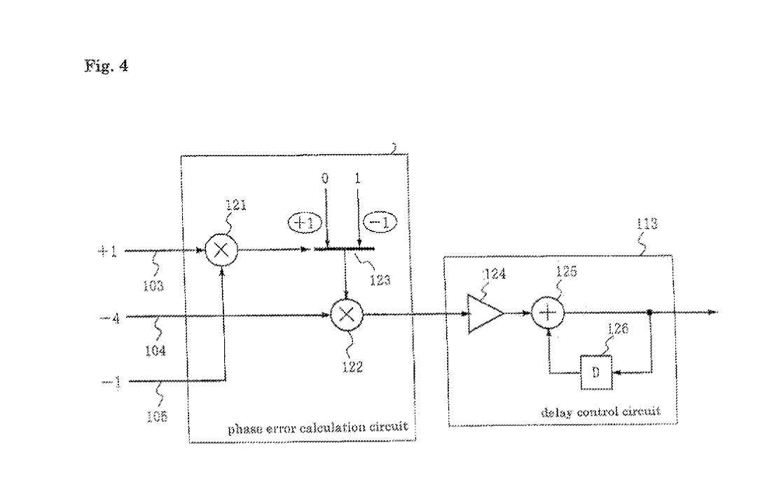

FIG. 4 shows examples of the phase error calculation circuit 112 and the delay control circuit 113.

The multiplier 121 is one which multiplies the sample value 103 and the sample value 105, and it here detects the rising up or the falling down. In other words, since the sample values 103 and 105 are +1 and −1, respectively, it turns out that when the multiplication result is −1, it is found that there is a rising up or a falling down.

The multiplexer 123 selects 1 when the result of the multiplier 121 is −1, that is, when the rising up or the falling down of the envelope signal 102 is detected, and selects 0 when the result of the multiplier 121 is +1.

The multiplier 122 multiplies the result of the multiplexer 123 band the sample value 104 to output the result as a phase error value. In other words, when the rising up or the falling down of the envelope signal 102 is detected, the phase error value is outputted, while when it is not the case, 0 is outputted.

The delay control circuit 113 filters the output of the phase error calculation circuit 112 to output a delay control signal.

In the delay control circuit 113, the gain amplifier 124 is one which amplifies the output of the phase error calculation circuit 112 by a predetermined value, and the adder circuit 125 and the D-flip flop 126 accumulates the output of the gain amplifier 124. Thereby, the delay control circuit 113 constitutes a primary low pass filter, and by controlling the band of the phase error value, the resistance to rapid changes and anti-noise property are enhanced.

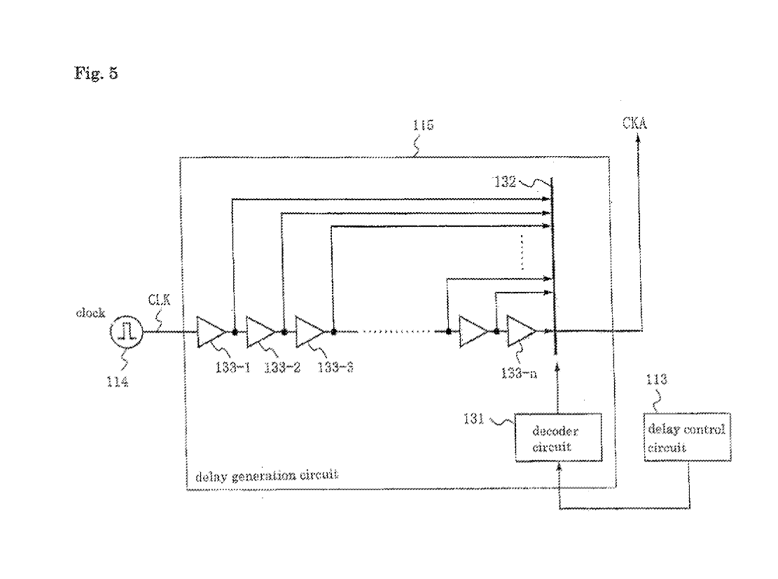

FIG. 5 illustrates an example of a delay generation circuit 115 which receives the delay control signal from the delay control circuit 113 and controls the phases of the sample clocks CKA, CKB, and CKC.

In FIG. 5, the delay circuits 133-1 to 133-n are delay circuits of the same construction. The multiplexer 132 is one which selects one among the outputs of the delay circuits 133-1 to 133-n, and the decoder circuit 131 decodes the output of the delay control circuit 113 to output only one signal that is selected among the inputs to the multiplexer 132. Hereinafter, an example of the decoding method will be described.

When the phase error value increases in the minus direction, as a control for taking synchronization from the delayed state, a sample timing may be made faster. That is, since the delay control signal may be made have a less delay stage number, the output of the delay circuit at the reference clock CLK side is selected.

Reversely, since in order to take synchronization from the advanced state, the sample timing may be made slower, i.e., the delay control signal may be made have a larger delay stage number, the output of the delay circuit at the sample clock CKA side is selected.

That is, when it is in the state of the synchronization being taken, the decoder circuit 131 is constituted such that the output of the delay circuit which is located at the central stage number is selected among the plural stages of the delay circuits. Herein, of course, the decoder circuit construction with having paid considerations on variations in the circuit and operation environments may be employed.

The sample clock CKA generated by the delay generation circuit 115 is then inputted to the delay generation circuit 116, the sample clock CKA is delayed by a predetermined amount in the delay generation circuit 116 to be outputted as sample clock CKB, the sample clock CKB is further inputted to the delay generation circuit 117 and it is delayed by a predetermined amount in the delay generation circuit 117 to be outputted as sample clock CKC.

Thereafter, the above-described feedback controls for the sample clocks CKA, CKB, and CKC are carried out and the values held in the D-flip flop 107 are successively outputted as the demodulated signals. Here, the output sample values 105 of the D-flip flop 110 may be made as the demodulated signals.

As described above, according to the synchronous control circuit of the first embodiment of the present invention, since the outputs of the two comparators which have predetermined threshold values as well as the A/D converter which calculates the phase error value are employed to adaptively control the phases of the sample clocks which sample the respective output values. In other words, the rising up or the falling down of the envelope signal are detected by the outputs of the two comparators, and the phases of the sample clocks for the comparators and the A/D converter are advanced or delayed according to the synchronization deviation amount of the output of the A/D converter at the detection of those. Thereby, the phase pulling-in or the tracking can be carried out in a short time without employing a plurality of A/D converters.

Additionally, thereby the circuit size required for taking synchronization of timings can be reduced as well as the power dissipation can be suppressed.

Besides, the band of the input signal 101 is not particularly restricted. That is, the bandwidth from the band that is used for a wireless communication by a general information communication apparatus to a so-called millimeter-wave band of about 60 GHz can be processed by the synchronization control circuit 118 according to the present invention.

In addition, the method for detecting the rising up and falling down of the envelope signal 102 are not limited to those which are described here. For example, when the binary sample values are 0 and 1, it can be easily realized by employing a logical product circuit. In addition, the filtering of the output of the phase error calculation circuit 112 may be carried out by employing, for example, a digital filter having other frequency characteristics, where an appropriate one may be selected depending on the band of the received signal and the modulation system.

### Second Embodiment

Next, a synchronization control circuit 205 according to a second embodiment of the present invention will be described.

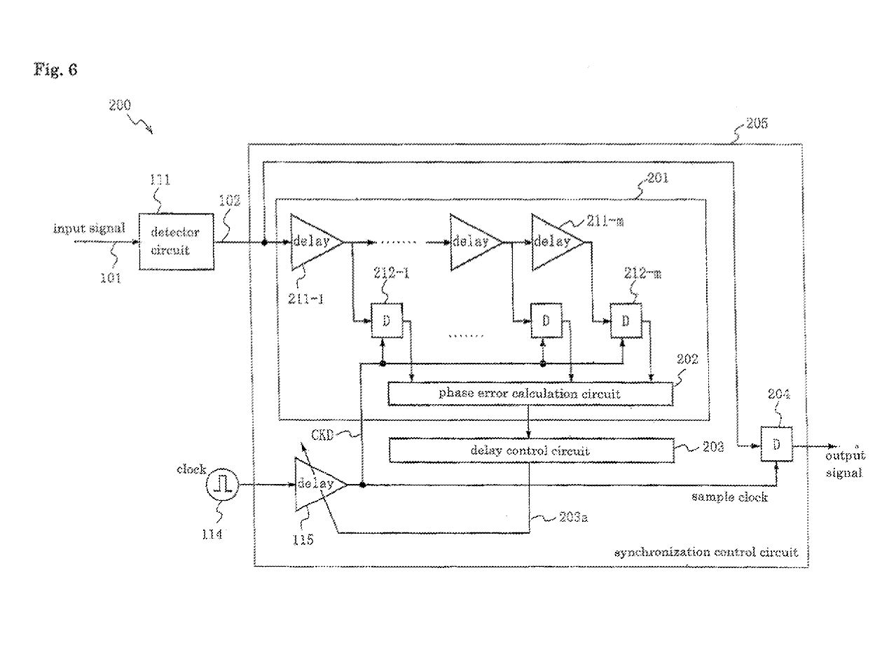

FIG. 6 is a construction diagram of a wireless receiving apparatus having a synchronous control circuit 205 according to a second embodiment of the present invention. In FIG. 6, the same reference numerals as in FIG. 1 denote the same constitutional elements.

In FIG. 6, the synchronization control circuit 205 is provided with a T/D converter 201, the delay control circuit 203, the delay generation circuit 115, and the D-flip flop 204.

The T/D converter 201 is one which converts the time to a digital signal, and it comprises delay circuits 211-1 to 211-m, the D-flip flop 212-1 to 212-m, and the phase error calculation circuit 202.

The delay circuits 211-1 to 211-m are circuits of the same construction having a predetermined delay time and these are vertically connected. The respective outputs of the delay circuits 211-1 to 211-m are inputted to the respective inputs of the D-flip flops 212-1 to 212-m, and the sampler clocks for the D-flip flops 212-1 to 212-m are supplied from the delay generation circuit 115. The outputs of these D-flip flops 212-1 to 212-m are inputted to the phase error calculation circuit 202, and the phase error value between the envelope signal 102 and the sample clock CKD is calculated by the phase error calculation circuit 202.

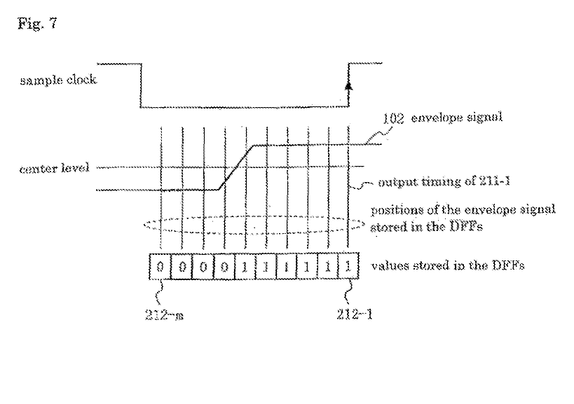

FIG. 7 is a diagram illustrating the relation between the envelope signal 102 and the sample clock CKD. As the operations of the D-flip flops 212-1 to 212-m, when the envelope signal 102 is captured at the rising up of the sample clock CKD, actually the envelope signal 102 is delayed by the envelope signal 102 passing through the delay circuits 211-1 to 211-m, and the result of the delayed envelope signal 102 is sampled by the D-flip flops 212-1 t 212-m. However, in FIG. 7, it is shown that the sample timing is equivalently delayed.

When there is a relationship in timings between the sample clock CKD and the envelope signal 102 as shown in FIG. 7, if the center level of the envelope signal 102 is made the threshold value for the delay circuits 211-1 to 211-m, 0s and 1s are stored in the D-flip flops 212-1 to 212-m as show in FIG. 7.

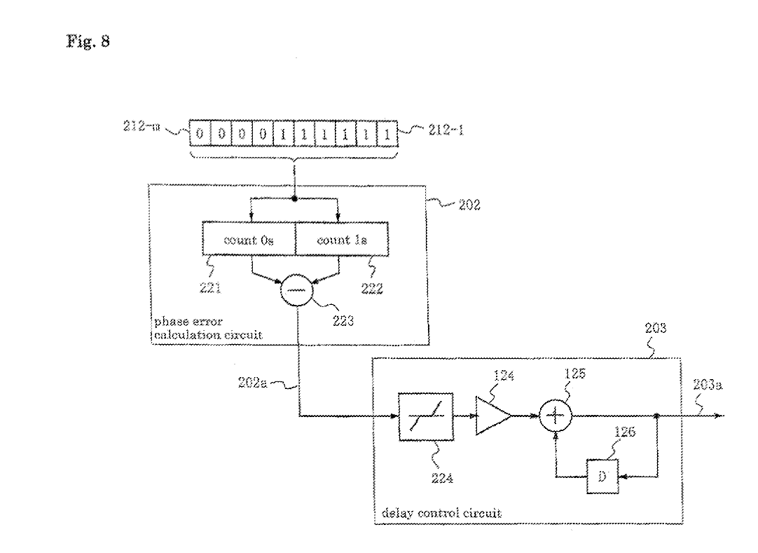

FIG. 8 shows a construction of a phase error calculation circuit 202 which calculates the phase. error value employing the output values of the D-flip flops 212-1 to 212-m, and a construction of the delay control circuit 203 which generates a delay control signal 203a from the output 202a of the phase error calculation circuit 202.

The phase error calculation circuit 202 is constituted comprising a counter 221 which counts the number of 0s which are held in the D-flip flops 212-1 to 212-m, a counter 222 which counts the number of 1s which are held therein, and the subtraction circuit 223 which calculates the difference between the output value of the counter 221 and the output value of the counter 222.

The delay control circuit 203 is constituted comprising the difference judging circuit 224, and a digital filter which has the same construction as the delay control circuit 113 in the above-described first embodiment. When the variations at the manufacturing as well as variations in the temperature and the power'supply voltage at the operation are considered, it is desired to control such that the absolute value of the difference between the number of 0s and the number of 1s is below a constant value. Accordingly, when the absolute value of the difference between the number of 0s and the number of 1s in the respective stage outputs of the D-flip flops 212-1 to 212-m is below a constant value, the difference judgment circuit 224 outputs 0 as the phase error value while in other cases it outputs a value that is obtained by subtracting a predetermined value from the difference in the numbers as a phase error value.

Here, a state where the synchronization is taken is obtained when the number of 0s and the number of 1s are equal to each other, i.e., when the output of the difference judging circuit 224 becomes zero. In other words, with referring to FIG. 7, that state is obtained by adjusting the sample clocks such that the rising up or the falling down of the envelope signal 102 comes to the vicinity of the enter of the L section of the sample clocks, i.e., by adjusting the delay time of the delay generation circuit 115. By doing so, the transition state of the envelope signal 102 would not come at the rising up of the sample clock, and the vicinity of the peak point of the envelope signal 102 would be sampled, thereby the demodulated data can be captured stably.

When there are a large number of 0s, the time interval between the rising up or the falling down of the envelope signal 102 and the rising up of the sample clock is short, and therefore, it is controlled such that the delay time of the delay generation circuit 115 is large. On the other hand, when there are a large number of 1s, the rising up or the falling down of the envelope signal 102 and the rising up of the sample clock is long, and therefore, it is controlled such that the delay time of the delay generation circuit 115 is small.

More concretely, the subtraction circuit 223 subtracts the output value of the counter 222 from the output value of the counter 221. More particularly, when there are a lot of 0s, the output of the subtraction circuit 223 is plus while when there are a lot of 1s, the subtraction circuit 223 is minus. The decoder circuit 131 is operated so as to select the delay circuits at the output side among the delay circuits 211-1 to 211-m and to select the delay circuits at the input side among those.

Thereafter, the envelope signal 102 is sampled by the sample clock CID which is outputted from the delay generation circuit 115, and the sample value is outputted as the demodulated signal 205a.

As described above, according to a synchronization control circuit according to the second embodiment, the phase of the sample clock which samples the output value is adaptively controlled employing a T/D converter, and thereby the pulling-in of the phase and tracking can be carried out in a short time without employing a plurality of A/D converters.

Additionally, thereby the circuit size required for taking synchronization of timings can be reduced as well as the power dissipation can be suppressed.

### Third Embodiment

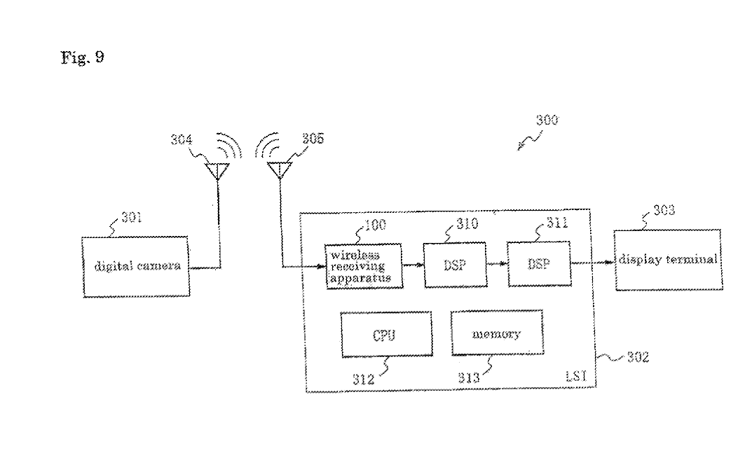

FIG. 9 is a diagram illustrating a construction of the video display apparatus 300 according to a third embodiment of the present invention, which includes an LSI which contains a wireless receiving apparatus which has installed a synchronization control circuit according to the first or the second embodiment of the present invention.

Next, the video display apparatus. 300 according to a third embodiment of the present invention will be described.

In FIG. 9, reference numeral 301 designates a digital camera which transmits data to the video display apparatus 300.

As described above, the video display apparatus 300 of the third embodiment is provided with the LSI 302 and the display terminal 303, and the LSI 302 includes a signal processor which performs detection, waveform equalization, error correction, control, modulation, demodulation, and data extraction employing the waveforms which are transmitted from such as the digital camera 301, and the wireless receiving apparatus 100 detects the waveform of the modulated signal which was transmitted wirelessly from the digital camera 301 to extract the data. The DSP 310 carries out the waveform equalization, the error correction, the control, the modulation, the demodulation, and the data extraction, and the like. The DSP 311 carries out the noise removal, white balancing, and γ correction processing of the video images, or noise removal or surround processing of the audio signal and the like, and has an interface with an external output. The CPU 312 carries out the control of the entire LSI. In addition, the memory 313 stores the program or data. In addition, the display terminal 303 emits tones of the audio data of the analogue or digital value as well as displays the video data on the basis of the decoded and reproduced signal outputted from the LSI 302.

By employing the wireless receiving apparatus 100 which has installed the synchronization control circuit according to the present invention for the video display apparatus 300, the following effects are obtained.

More particularly, as the digital camera 301, there is one which has pixels of exceeding ten million even in a compact type one, and in such a digital camera, the data quantity that is required for a piece of picture is from several MBs to over several ten MBs. While in order to transmit several tens pieces of such photographs, the transmission is carried out using a storage media or a cable, if this is transmitted by wireless, the handing of the data transmission would be eased, and the video data would be able to be displayed on a display terminal without being conscious with the connection being required.

Additionally, when the function of receiving data with wireless is integrated into an LSI, it is important that the circuit size is small and that in order to process the reception of a large amount of data at a high speed, the pulling-in of the synchronization and the tracking can be carried out in a short time. By employing the wireless receiving apparatus which has installed the synchronization control circuit according to the first and the second embodiment of the present invention, the pulling-in of synchronization and the tracking can be carried out in a short time, and further, reductions in the circuit size and the power dissipation can be carried out.

In addition, the wireless receiving apparatus which has installed the synchronization control circuit of the present invention can be utilized not only for the video display apparatus 300 but also for data transmission in a portable terminal such as a portable telephone or a portable audio player.

### APPLICABILITY IN THE INDUSTRY

A synchronization control circuit and a video display apparatus having installed this synchronization control circuit according to the present invention are useful in view of that the circuit size and the power dissipation of a data receiving terminal which wirelessly receives data can be reduced.

1. A synchronization control circuit for receiving an envelope signal of a modulation signal and a reference clock signal, and establishing timing synchronization between the modulation signal and the reference clock signal, which comprises:
a first sampling means for sampling said envelope signal at a first sampling timing to produce a first sample value;
a second sampling means for sampling said envelope signal at a second sampling timing to produce a second sample value;
a third sampling means for sampling said envelope signal at a third sampling timing to produce a third sample value;
a phase error calculation means for calculating a phase error value indicating the amount of synchronization deviation between said modulation signal and said reference clock signal using said first, second, and third sample values;
a delay control means for generating a delay control signal indicating a required delay amount on the basis of the phase error value which is outputted from the phase error calculation means; and
a delay generation means for generating said first, second, and third sampling timing by delaying said reference clock signal based on said delay control signal.

2. A synchronous control circuit as defined in claim 1, wherein
said phase error calculation means detects the rising up or falling down of said envelope signal using said first and third sample values among said successive first, second, and third sample values, and calculates the phase error value using said second sample value when said rising up or falling down of said envelope signal is detected, and
said delay control means generates said delay control signal so that said phase error value becomes zero.

3. A synchronous control circuit as defined in claim 1, wherein said delay generation means comprises:
a first delay means for generating said first sample timing by delaying said externally inputted reference clock signal according to said delay control signal;
a second delay means for generating said second sample timing by delaying the output of said first delay means by a predetermined amount; and
a third delay means for generating said third sample timing by delaying the output of said second delay means by a predetermined amount.

4. A synchronous control circuit as defined in claim 1, wherein
said first and third sampling means comprise two-value or three-value comparator, respectively, and said second sampling means is an A/D converter of two or more bits.

5. A synchronous circuit as defined in claim 1, wherein either of said first sample value or said third sample value is employed as demodulated data.

6. A synchronous control circuit for receiving an envelope signal of a modulation signal and a reference clock signal, and establishing timing synchronization between the modulation signal and the reference clock signal, which comprises:
a T/D conversion means for subjecting time-digital conversion to said envelope signal by sampling clocks;
a phase error calculation means for calculating a phase error value indicating the amount of synchronization deviation between said modulation signal and said reference clock signal using the output of said T/D conversion means;
a delay control means for generating a delay control signal indicating a required delay amount on the basis of the phase error value which is outputted from the phase error calculation means; and
a delay generation means for generating said sampling clocks by delaying said reference clock signal according to said delay control signal.

7. A synchronous control circuit as defined in claim 1, wherein
said T/D conversion means includes a plurality of stages of delay means which receive an envelope signal of said modulation signal and a plurality of sampling means for sampling the respective output values of said plurality of stages of delay means.

8. A synchronous control circuit as defined in claim 7, wherein
said plurality of sampling means are ones which sample the respective output values of the plurality of stages of delay means by two values, and
said delay control means generates said delay control signal so that the difference in the respective numbers of the two values which are respectively sampled by the plurality of sampling means is lower than a constant value.

9. A video display device comprising:
a wireless receiver apparatus including a detection means for detecting an envelope signal of a modulation signal, a clock generation means for generating a reference clock signal, a synchronous control circuit for synchronizing the timings of the modulation signal and the reference clock signal;
an LSI having a signal processor for demodulating said modulation signal including audio data and video data on the basis of the demodulated data which is obtained by said wireless receiver apparatus; and
a display terminal for receiving the demodulated signal from said LSI and emitting sound of said demodulated audio data as well as displaying said demodulated video data; wherein
said synchronous control circuit comprises:
a first sampling means for sampling said envelope signal at a first sampling timing to produce a first sample value;
a second sampling means for sampling said envelope signal at a second sampling timing to produce a second sample value;
a third sampling means for sampling said envelope signal at a third sampling timing to produce a third sample value;
a phase error calculation means for calculating a phase error value indicating the amount of synchronization deviation between said modulation signal and said reference clock signal using said first, second, and third sample values;
a delay control means for generating a delay control signal indicating a required delay amount on the basis of the phase error value which is outputted from the phase error calculation means; and
a delay generation means for generating said first, second, and third sampling timing by delaying said reference clock signal based on said delay control signal.

10. A video display apparatus comprising:
a wireless receiver apparatus including a detection means for detecting an envelope signal of a modulation signal, a clock generation means for generating a reference clock signal, a synchronous control circuit for synchronizing the timings of the modulation signal and the reference clock signal;
an LSI having a signal processor for demodulating said modulation signal including audio data and video data on the basis of the demodulated data which is obtained by said wireless receiver apparatus; and
a display terminal for receiving the demodulated signal from said LSI and emitting sound of said demodulated audio data as well as displaying said demodulated video data; wherein
said synchronous control circuit comprises:
a T/D conversion means for subjecting said envelope signal to time-digital conversion by sampling clocks;
a phase error calculation means for calculating a phase error value indicating the amount of synchronization deviation between said modulation signal and said reference clock signal using the output of said T/D conversion means;
a delay control means for generating a delay control signal indicating a required delay amount on the basis of the phase error value which is outputted from the phase error calculation means; and
a delay generation means for generating said sampling clocks by delaying said reference clock signal according to said delay control signal.
